(19) United States
(12) Patent Application Publication
(10) Pub. No.: US 2008/0270418 A1
(43) Pub. Date: Oct. 30, 2008

(54) Method for registering a domain name and signing up with a search website using a computer network service provider on behalf of a user, and a modem

(76) Inventors: Te-Tsung Chen, Taipei (TW); Fa-An Hsieh, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/878,325

(22) Filed: Jul. 24, 2007

(30) Foreign Application Priority Data
Apr. 27, 2007 (TW) 096115023

(51) Int. Cl. G06F 17/30

(52) U.S. Cl. 707/10; 707/E17.032

(57) ABSTRACT

A method for registering a domain name and signing up with a search website using a computer network service provider on behalf of a user includes: (a) enabling a computer network service provider to establish a database, which stores therein identity identification information agreed upon with the user; (b) enabling the computer network service provider to receive a message from the user, the message including identity identification information and domain name application data; (c) enabling the computer network service provider to authenticate the identity identification information contained in the message; (d) applying for registration of the domain name after successful authentication; and (e) signing up with at least one search website after successful registration of the domain name.

### CROSS-REFERENCE TO RELATED APPLICATION

This application claims priority of Taiwanese Application No. 096115023, filed on Apr. 27, 2007.

### BACKGROUND OF THE INVENTION

1. Field of the Invention

The invention relates to a method for registering a domain name and signing up with a search website, more particularly to a method for registering a domain name and signing up with a search website using a computer network service provider on behalf of a user, and to a modem.

2. Description of the Related Art

When a user wants to set up a website, the setup procedures, which include designing web pages, applying for a webspace for the web pages, naming the website, etc., would be simpler if the webspace is applied for with a website service provider. For instance, for a user applying for a webspace for an on-line store website with a network service provider like Yahoo, he/she only needs to go to the website of Yahoo to fill in the name of the store website, provide an introduction of the store website and relevant data, and pays a fee, if required, to get the website hosted. However, if the user wants to store the web page data in his/her own computer, the process for constructing the website would be more complicated. Aside from storing the web page data in his/her computer and establishing a network connection, the user further needs to carry out the following steps in order to complete the entire website setup process.

1. Since the IP (Internet Protocol) address of the user's computer is a string of numbers (e.g., 123.123.123.123), it is difficult for most people to remember. Therefore, the user needs to register a domain address or domain name (e.g., www.abc.com) for the IP address with a specific website (such as the TWNIC website). If the domain name is available and a fee, if required, is paid, others can then browse the user's website, upon inputting the domain name of the website through a domain name server (DNS server) that can determine the IP address of the user's computer from the domain name.

2. In order to make more people aware of the website, one way to promote the website is to register the web address with various search engines or search websites (such as Yahoo). The user needs to go to a register page of each of the search websites to submit data of his/her domain name, classification or category (e.g., “restaurant”), etc., and pay a required fee.

It is evident from the foregoing that setting up a website involves complicated registration processes, such as domain name registration and web address registration. Separate registration is time-consuming and is too complicated for ordinary users who are not computer professionals, and those who may want to set up a website are likely to get frustrated.

Moreover, since computer equipment used by an ordinary user generally is not a professional network server, and since hosting a website requires use of a high-performance network server to store website data for browsing by others, the original computer equipment of the user may be inadequate, and an additional network server may have to be purchased, which means additional expenses. All of this discourages the user from setting up a website on his/her own.

### SUMMARY OF THE INVENTION

Therefore, one object of the present invention is to provide a method for registering a domain name and signing up with a search website using a computer network service provider on behalf of a user, in which the computer network service provider performs application processes in connection with “domain name registration” and “website signing-up” on behalf of the user, so that the user is able to quickly construct a website with some simple operations, without going through complicated application operations.

Accordingly, in the method for registering a domain name and signing up with a search website using a computer network service provider on behalf of a user of the present invention, the user has already purchased a product or a service. The method includes the following steps: (a) enabling the computer network service provider to establish a database, which has identity identification information of the product or service stored therein; (b) enabling the computer network service provider to receive a message from the user, the message containing identity identification information and domain name application data; (c) enabling the computer network service provider to authenticate whether the identity identification information in the message has been stored in the database; (d) upon successful authentication, enabling the computer network service provider to apply for registration of the domain name; and (e) enabling the computer network service provider to sign up with at least one search website using the domain name that was successfully registered.

Another object of the present invention is to provide a modem which is loaded with identity identification information to be authenticated by a computer network service provider and which has a built-in network server that can execute general functions of a website server when connected to the Internet.

Accordingly, the modem of the present invention is connected to a computer, and is further connected to a computer network service provider via a wide-area network. The modem includes a server module containing identity identification information, and a processing module.

The server module includes a local-area network interface, a storage unit, and a control unit. The local-area network interface is coupled to the computer to receive domain name application data therefrom. The storage unit stores web page data to be browsed by other network devices using a successfully registered domain name. The control unit appends the domain name application data to the identity identification information for forming a message. The processing module transmits the message to the computer network service provider via the wide-area network.

Since the application processes in connection with domain name registration and signing up with search websites are handled by the computer network service provider in the method of the present invention, time for conducting complicated application operations can be saved. In this way, the user may be encouraged to set up a website on his/her own.

### BRIEF DESCRIPTION OF THE DRAWINGS

Other features and advantages of the present invention will become apparent in the following detailed description of the preferred embodiment with reference to the accompanying drawings, of which:

FIG. 1 is a schematic circuit block diagram to illustrate a preferred embodiment of a modem for enabling a computer network service provider to authenticate identity of a user according to the present invention;

FIG. 2 is a schematic diagram to illustrate a system architecture implementing a method for registering a domain name and signing up with a search website using a computer network service provider on behalf of a user according to the present invention;

FIG. 3 is a flowchart to illustrate how a modem of the present invention communicates with a computer network service provider;

FIG. 4 is a schematic diagram to illustrate an edit screen for use by the user to create a web page, the edit screen having a “save key”;

FIG. 5 is a schematic diagram to illustrate an application web page for the user to fill in application data, the application web page having a “send key”; and

FIG. 6 is a flowchart to illustrate a preferred embodiment of the method for registering a domain name and signing up with a search website using a computer network service provider on behalf of a user according to the present invention.

### DETAILED DESCRIPTION OF THE PREFERRED EMBODIMENT

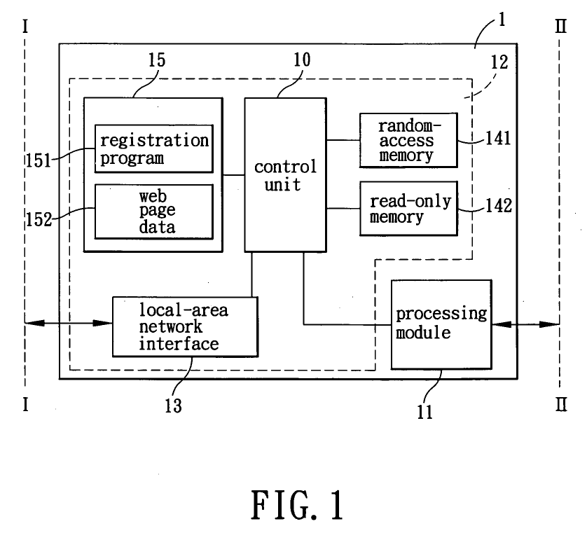

Referring to FIG. 1, a modem 1 referred to in the present invention includes a processing module 11 and a server module 12. The processing module 11 may be an ADSL processing module and a control chip integrating components that include a control unit, a network processing unit, a front end processing unit, a storage unit, a random-access memory, etc.

The server module 12 includes a control unit 10 and a local-area network interface 13. A storage unit of the server module 12 includes a random-access memory 141, a read-only memory (ROM) 142, and a memory card 15. The server module 12 serves as a web server in this invention. The memory card 15 is used to store a registration program 151 and web page data 152.

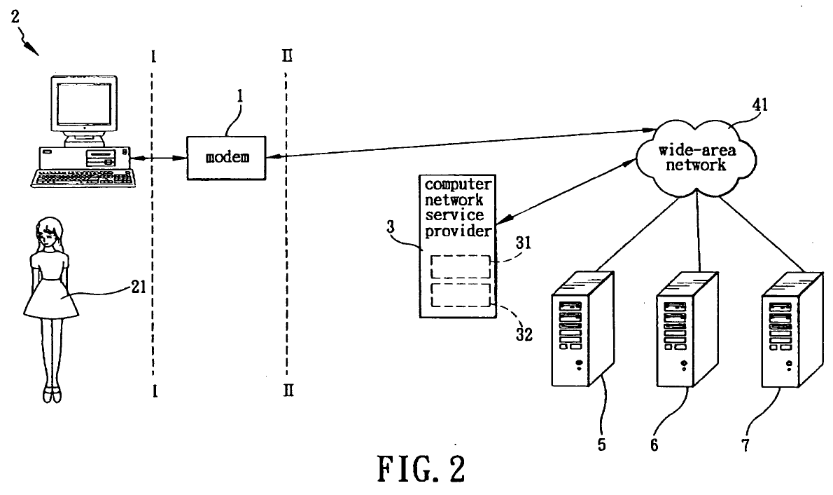

Referring to FIGS. 1 and 2, the method for registering a domain name and signing up with a search website using a computer network service provider 3 on behalf of a user 21 according to the present invention will be illustrated by way of a preferred embodiment. A system architecture to implement the preferred embodiment includes the aforesaid modem 1, a computer 2, a wide-area network 41, the computer network service provider 3, a domain name registration platform 5, a search engine or search website 6 for handling website registration, and a network device 7. The computer 2 permits input of domain name application data by the user 21. Content of the application data is to request the computer network service provider 3 to register a domain name with the domain name registration platform 5 and to sign up with at least one search website 6 on behalf of the user 21. The wide-area network 41 refers in general to a group including a public switched telephone network (PSTN), a leased line, a packet switching digital network (PSDN), an asymmetric digital subscriber line (ADSL) network and a cable modem network. Since this belongs to the prior art and is irrelevant to the crucial feature of the present invention, the wide-area network 41 will not be discussed in detail herein.

The modem 1 is connected to the computer 2 and the wide-area network 41. The server module 12 of the modem 1 contains identity identification information. The local-area network interface 13 is coupled to the computer 2, and is used to receive the domain name application data inputted by the user 21. The web page data 152 stored in the memory card 15 is for browsing by other network devices 7 using a domain name that was successfully registered. The control unit 10 appends the domain name application data to the identity identification information, and encrypts and generates packets of the data for forming a message. The processing module 11 transmits the message to the computer network service provider 3 through the wide-area network 41.

Referring to FIG. 2, the computer network service provider 3 referred to in this invention may be an Internet access provider (such as America Online), an Internet platform provider (such as Yahoo), or an Internet content provider which, through the wide-area network 41, provides a diverse array of services, including providing Internet access, providing Internet platforms, providing Internet contents, providing domain name application services, and providing services of signing up with various search websites 6.

The computer network service provider 3 may be a manufacturer and/or distributor of computers and/or peripheral equipment, without limiting the present invention thereto. The computer network service provider 3 may alternatively be a telecommunications service provider, a search engine service provider, or a company providing other network services and affiliated with a manufacturer and/or distributor of computers and/or peripheral equipment by contract or agreement.

The computer network service provider 3 provides a consumer or company (hereinafter referred to as the user 21) that purchased a computer product or peripheral equipment, such as the modem 1 of the present invention, with an all-in-one service to enable the user 21 to construct a website on his/her own. The service includes applying for registration of a domain name with the domain name registration platform 5 of a competent authority, such as VeriSign, ICANN, etc., on behalf of the user 21, and signing up with the search website 6 (such as Yahoo) using the registered domain name on behalf of the user 21. The method as to how the computer network service provider 3 provides the all-in-one service will be described hereinbelow.

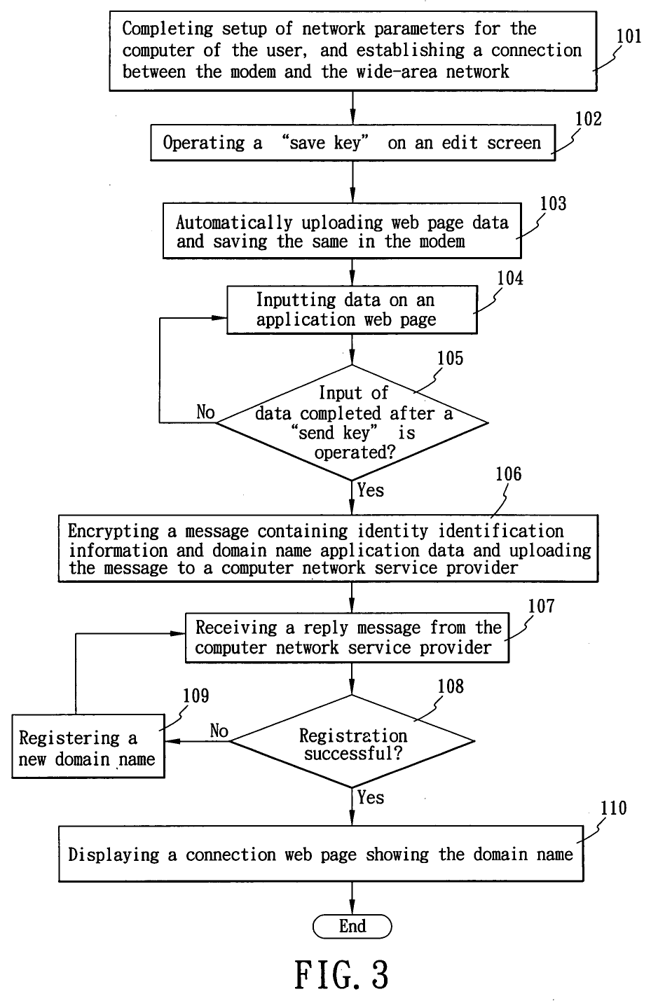

Referring to FIGS. 2 and 3, supposing the user 21 wants to do e-commerce, after purchasing the modem 1 of this invention, the user 21 applies for a fixed physical web address (IP address) from the computer network service provider 3 or another Internet access provider. The computer network service provider 3 or said another Internet access provider completes the setup of network parameters for the computer 2 of the user 21, and establishes a connection between the modem 1 and the wide-area network 41 so that the computer 2 is connected to the Internet (step 101).

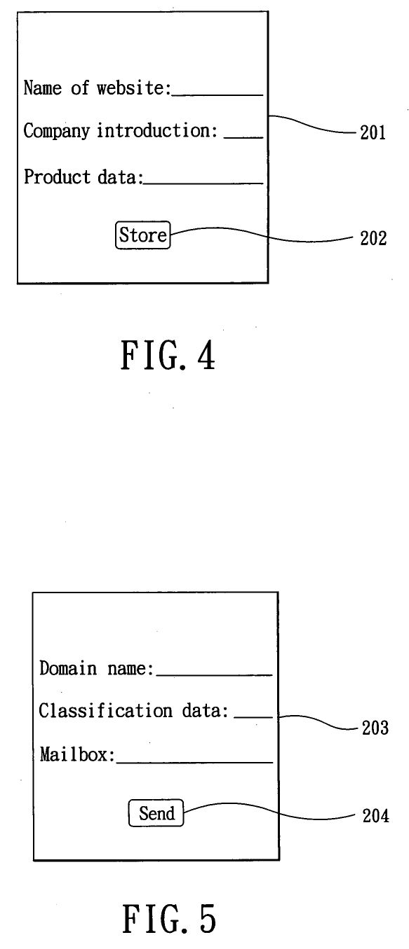

Referring further to FIG. 4, the user 21 subsequently puts a storage medium (such as an optical disk) which came with the modem 1 into a storage medium reading unit (such as an optical disk drive) of the computer 2 to load a web page creation program into the computer 2. An edit screen 201 will appear on a display of the computer 2 to allow the user 21 to edit the web page content on the edit screen 201 and to fill in or insert the desired text and graphic data, such as name of the website, store or company introduction, product information, etc.

After editing, when the user 21 operates a “save key” 202 on the edit screen 201 (step 102), the web page data 152 will be automatically uploaded to and saved in the modem 1 (step 103). In the preferred embodiment, the web page data uploaded to the modem 1 is stored in the memory card 15 and the random-access memory (RAM) 141 of the modem 1. The purpose of storing the web page data in the random-access memory 141 is to allow others to quickly access the data.

Referring further to FIG. 5, after construction of the web page data 152, the registration program 151 will be loaded. Since an application web page 203 generated through the registration program 151 is written in hyper text markup language (HTML), the registration program 151 will first cause the computer 2 to run a browser to display the application web page 203 for the user 21 to input domain name application data on the application web page 203 (step 104).

The domain name application data includes a domain name to be registered, website classification data (e.g., restaurant), and e-mail box data. The classification data of the website is to be used by the computer network service provider 3 when signing up with the search website 6 on behalf of the user 21. The e-mail box data enables the computer network service provider 3 to communicate with the user 21, for instance, to notify the user 21 to pay website maintenance fees for a certain year.

The application web page 203 has a “send key” 204. When the user 21 operates the “send key” 204, the computer 2 will determine whether input of data has been completed (step 105). If negative, input of data is required (step 104). If affirmative, the registration program 151 will automatically append the domain name application data to the identity identification information, encrypt the combined data, and upload the combined data to the computer network service provider 3 (step 106). Thereafter, a reply message is received from the computer network service provider 3 (step 107), and a determination is made as to whether the registration is successful (step 108). If unsuccessful, this indicates that the previously inputted domain name is unavailable, and a new domain name registration is required (step 109). If successful, a connection web page showing the domain name will be displayed (step 110).

Referring once again to FIG. 1, the registration program 151 is executed by the control unit 10, which appends to the encrypted message to be sent the IP address and three sets of identity identification information, namely, a medium access control address (MAC address) acquired from the local-area network interface 13 of the modem 1, a universally unique identifier (UUID) acquired from the server module 12 of the modem 1, and an MSG authentication code. What these three sets of identity identification information stand for is set forth below.

The local-area network interface 13 (i.e., the network card) which is installed in the modem 1 is assigned a unique identification code when delivered from factory. The unique identification code is known as the medium access control address or physical address, which consists of 6 bytes, such as 00-07-95-a5-ea-93.Server.

The read-only memory 142 of the server module 12 of the modem 1 has a universally unique identifier (UUID), which is 128-bit data and which is not a serial number. A portion of the UUID is generated by random numbers.

The MSG authentication code is 1024-bit data, and is also stored in the read-only memory 142. The MSG authentication code is a character string generated from the aforesaid UUID and the MAC address based on a specific coding principle.

The computer network service provider 3 may be a hardware manufacturer of the modem 1, as mentioned above. Therefore, the computer network service provider 3 has a database 31 that stores the three sets of identity identification information of the modem 1 (i.e., MAC address, UUID and MSG authentication code). Even if the computer network service provider 3 is not a hardware manufacturer, the database 31 of the computer network service provider 3 can still have the three sets of identity identification information stored therein by contract or agreement with the hardware manufacturer.

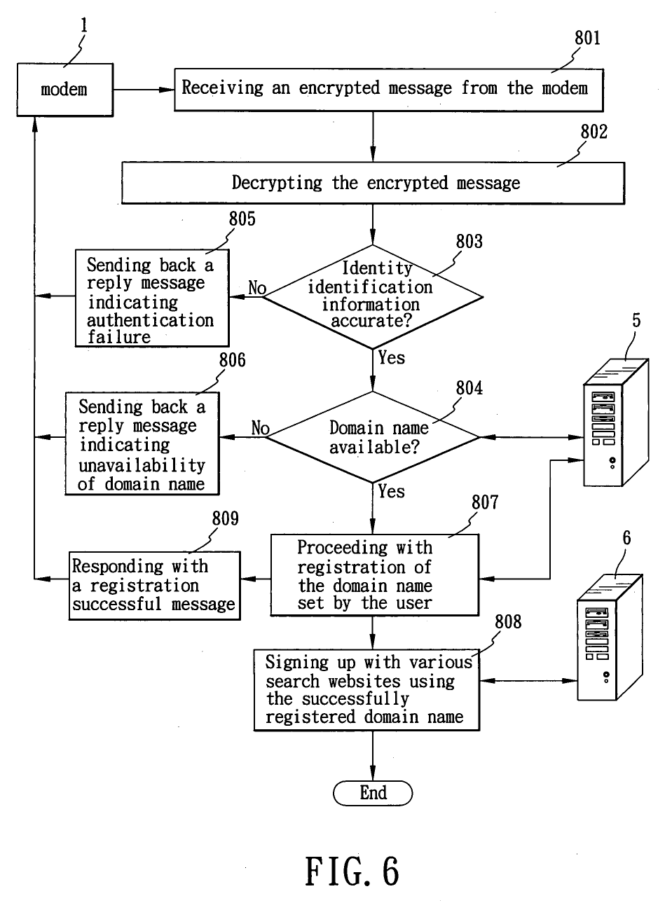

Referring to FIGS. 2 and 6, when the computer network service provider 3 receives an encrypted message from the modem 1 (step 801), a processing unit 32 of the computer network service provider 3 will first decrypt the encrypted message (step 802), and checks the accuracy of the identity identification information contained therein against the information stored in the database 31 (step 803). If the received identity identification information is incorrect, a reply message indicating authentication failure is sent back (step 805). If the authentication is successful, the computer network service provider 3 will perform the all-in-one service based on the domain name application data.

The computer network service provider 3 first of all carries out a domain name registration procedure. If the computer network service provider 3 is an authorized domain name registry, such as VeriSign authorized by ICANN, it can directly handle the registration procedure. Otherwise, the computer network service provider 3 will submit a registration application to an authorized domain name registry (such as the domain name registration platform 5).

When the application is being processed, a check is conducted to see if the applied-for domain name is available (step 804). If the domain name is unavailable, a reply message indicating unavailability of the domain name is sent to the user 21 (step 806). If the domain name is available, registration based on the domain name submitted by the user 21 proceeds (step 807). If the registration is successful, aside from responding with a registration successful message (step 809), the computer network service provider 3 will proceed with a next procedure, i.e., to sign up with various search websites 6 using the successfully registered domain name on behalf of the user 21 (step 808).

Referring to FIGS. 1 and 3, if the domain name set by the user 21 cannot be successfully registered, the computer network service provider 3 will notify the user 21 by e-mail, so that the user 21 can apply once again according to steps 104 to 106, or the user 21 can notify the computer network service provider 3 of the new domain name by e-mail so that the computer network service provider 3 can once again proceed with the aforesaid procedure.

In the above-described embodiment, the method of the present invention is applied to an electronic product, i.e., the modem 1, but it should be understood that the method of the present invention is not limited thereto. On the contrary, the method according to the present invention can be applied to diverse products including electronic products, mechanical products, therapeutic products, and other products that are not listed herein. In addition, the method of the present invention can be applied to “services” sold by businesses. For example, a beauty parlor business launching a skin care product line can enjoy a special offer from the computer network service provider 3 to register a domain name and to sign up with the search website 6.

In the above preferred embodiment, the user 21 uses the optical disk that came with the modem 1 to edit web pages. However, the present invention can also enable the user 21 to connect to the website of the computer network service provider 3 to complete construction of the web page data 152, and thus is not limited to the above-illustrated example of bundled software.

Furthermore, in the above embodiment, the identity identification information is obtained from the codes of the hardware equipment. Alternatively, the identity identification information can be determined in other ways depending on different products and services, for instance, set upon purchase by the consumer or agreed upon with the consumer.

In sum, in the method for registering a domain name and signing up with a search website using a computer network service provider on behalf of a user according to the present invention, the user 21 can have the computer network service provider 3 automatically apply for a domain name and sign up with search websites on his/her behalf after constructing the web pages simply by inputting and transmitting the domain name application data using the computer 2 of the user 21. Therefore, the user 21 can easily set up his/her exclusive website even if he/she is not a computer professional.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. A method for registering a domain name and signing up with a search website using a computer network service provider on behalf of a user, the user having purchased a product or service, said method comprising the following steps:
(a) enabling the computer network service provider to establish a database, which has identity identification information of the product or service stored therein;
(b) enabling the computer network service provider to receive a message from the user, the message containing identity identification information and domain name application data;
(c) enabling the computer network service provider to authenticate whether the identity identification information in the message has been stored in the database;
(d) upon successful authentication, enabling the computer network service provider to apply for registration of the domain name; and
(e) enabling the computer network service provider to sign up with at least one search website using the domain name that was successfully registered.

2. The method according to claim 1, wherein, in step (d), availability of the domain name is checked such that a reply message indicating unavailability of the domain name is sent to the user if the domain name is unavailable, and such that a reply message indicating successful registration of the domain name is sent to the user and step (e) is subsequently carried out if the domain name is available.

3. The method according to claim 1, wherein the domain name application data includes a domain name that the user intends to register, and website classification data.

4. The method according to claim 1, wherein the computer network service provider is one of an Internet access provider, an Internet platform provider, and an Internet content provider.

5. The method according to claim 1, wherein the identity identification information is a code of hardware equipment.

6. A method for registering a domain name and signing up with a search website using a computer network service provider on behalf of a user, said method comprising the following steps:
(a) enabling the computer network service provider to establish a database, which stores identity identification information agreed upon with the user;
(b) enabling the computer network service provider to receive a message from the user, the message containing identity identification information and domain name application data;
(c) enabling the computer network service provider to authenticate whether the identity identification information contained in the message has been stored in the database;
(d) upon successful authentication, enabling the computer network service provider to apply for registration of the domain name; and
(e) enabling the computer network service provider to sign up with at least one search website using the domain name that was successfully registered.

7. The method according to claim 6, wherein, in step (d), availability of the domain name is checked such that a reply message indicating unavailability of the domain name is sent to the user if the domain name is unavailable, and such that a reply message indicating successful registration of the domain name is sent to the user and step (e) is subsequently carried out if the domain name is available.

8. The method according to claim 6, wherein the domain name application data includes a domain name that the user intends to register, and website classification data.

9. The method according to claim 6, wherein the computer network service provider is one of an Internet access provider, an Internet platform provider, and an Internet content provider.

10. A modem comprising:
a server module containing identity identification information, said server module including
a local-area network interface adapted to be coupled to a computer for receiving domain name application data therefrom,
a storage unit storing web page data to be browsed by other network devices using a successfully registered domain name thereof, and
a control unit for appending the domain name application data to the identity identification information for forming a message; and
a processing module for transmitting the message to a computer network service provider via a wide-area network.

11. The modem according to claim 10, wherein the identity identification information is one of a medium access control address of said local-area network interface, a universally unique identifier of said server module, and an authentication code generated from the universally unique identifier and the medium access control address based on a specific coding principle.

12. The modem according to claim 10, wherein said storage unit includes a random-access memory.

13. The modem according to claim 10, wherein said control unit further encrypts the message prior to transmission to the computer network service provider via said processing module.

14. A method for registering a domain name using a computer network service provider on behalf of a user, the user having purchased a product or service, said method comprising the following steps:
(a) enabling the computer network service provider to establish a database, which has identity identification information of the product or service stored therein;
(b) enabling the computer network service provider to receive a message from the user, the message containing identity identification information and domain name application data;
(c) enabling the computer network service provider to authenticate whether the identity identification information in the message has been stored in the database; and
(d) upon successful authentication, enabling the computer network service provider to apply for registration of the domain name.
